(19) United States
(12) Patent Application Publication
(10) Pub. No.: US 2003/0222059 A1
(43) Pub. Date: Dec. 4, 2003

(54) High energy beam cladding

(75) Inventors: Joel Alan De Kock, New Richmond, WI (US); Anthony Mark Doehrmann, New Richmond, WI (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Preco Laser system, L.L.C., Somerset, WI

(21) Appl. No.: 10/454,073

(22) Filed: Jun. 4, 2003

Related U.S. Application Data
(60) Provisional application No. 60/386,009, filed on Jun. 4, 2002.

(51) Int. Cl. B23K 26/00

(52) U.S. Cl. 219/121.63

(57) ABSTRACT

A system and method for cladding material onto a substrate involves heating the substrate using a high energy beam and depositing molten clad material via a non-contact transfer process onto the substrate in advance or coincident with a focal area of the high energy beam.

### CROSS-REFERENCE TO RELATED APPLICATION(S)

This application claims priority from provisional application serial No. 60/386,009 filed on Jun. 4, 2002, and entitled “High Energy Beam Cladding.”

### BACKGROUND OF THE INVENTION

The present invention relates to a system and method for area treatment or area improvement of a surface using a high energy beam. More specifically, the present invention relates to a system and method for heating a substrate surface with a high energy beam while simultaneously spray depositing clad material onto the substrate to achieve a fusion or metallurgical bond between the clad material and the substrate.

Large complex machinery is expensive to produce. To control costs, such machines are often built using low-grade or inexpensive materials, such as carbon steel. While such low-grade materials are subject to corrosion, producing the same machine using corrosion resistant materials would be cost prohibitive. However, it is possible to treat the surface of such low-grade materials with corrosion resistant materials in order to prevent corrosion and to extend the usable life of the machine. This type of treatment is referred to as “area treatment”, and it can be performed with corrosion resistant materials or with materials having other material characteristics, such as hardness, conductivity and the like.

Generally, crevices tend to trap moisture, which leads to oxidation and corrosion. With respect to large machinery, typically crevices exist wherever parts come together. For example, hinged joints, bolts and other fasteners all provide crevices of a sort which can trap moisture. In particular, crevice corrosion in areas near seals can result in costly repairs, both because such parts can be difficult and time consuming to replace and because deterioration of a part adjacent a seal can lead to larger problems if the problem is not detected at an early stage.

Cladding is a technique for area treating a workpiece with a deposit of material having desired characteristics (such as corrosion resistance). Cladding involves bonding a deposit of material onto a substrate. Typically, the cladding deposit is relatively thin, as compared with the thickness of the substrate. The goal of most cladding operations is to form a sound interfacial bond between the deposit and the substrate without diluting the cladding deposit with substrate material and without altering the material properties (such as corrosion resistance, electron mobility, and the like) of the cladding deposit. Ideally, the cladding material establishes a fusion bond with the substrate.

There are many known cladding processes, including laser, chemical (electrolysis), welding, spraying, plasma arc, chemical vapor deposition, physical vapor deposition, mechanical plating, and electrochemical deposition. In the laser cladding art, two common methods of supplying the cladding material are pre-placement of cladding material powder onto the substrate and inert gas propulsion of cladding material powder into the path of the laser beam (off-axis delivery or coaxial delivery).

Cladding with a powder involves scanning a laser beam over the pre-placed or propulsed powder. The energy of the laser beam melts the powder onto the substrate, thereby cladding the substrate. However, cladding with powder is susceptible to contamination and porosity (voids), resulting in incomplete fusion of the cladding to the substrate or inclusions and voids within the deposit. Moreover, propulsed powder placement has a low clad capture rate caused by divergence by the powder stream and incomplete interaction as it is exposed to the beam.

Porosity, uneven deposition, and undercut contribute to failures in the cladding deposit, such as voids, cracking, corrosion, separation, and the like. Where cladding is added to prevent corrosion, or where it is located near a seal, a defective clad deposit will result in product failure.

In the welding arts, it is known to transfer a deposit onto a substrate via a process called “short circuit transfer” or via a spray or globular transfer. In the traditional Metal Inert Gas (MIG) short circuit transfer process, a consumable wire is held on a spool and fed automatically to a torch or gun through a nozzle and into the weld arc. The short circuit transfer gets its name from the welding wire actually “short circuiting” (touching) the base metal or substrate many times per second. When the welding gun trigger is pressed, the electrode wire feeds continuously from the wire feeder, through the gun, and to the weld arc, repeatedly touching the substrate or base metal. Each time the short circuit is completed, a piece of the wire melts off onto the substrate.

Generally, in the traditional MIG short circuit transfer process, a current is applied to the wire. When the wire touches the base metal, there is no arc and the current flows through the wire and the base metal. The current flow causes a magnetic field to develop around the wire. Typically, the wire has difficulty supporting all the current flowing through the wire. As resistance builds up in the wire, the wire heats, and the tip of the wire begins to melt. The magnetic field squeezes the melting wire, assisting the wire in separating from the molten tip. As the wire separates, the current often continues to rise, arcing across the small gap between the wire and the separated tip. The arc across the small gap causes current surges during and immediately after each short circuit contact, resulting in arc instability and spatter. Specifically, after separation, the arc is “on” and the heat of the arc causes the weld puddle to flatten out (in a stable arc), but when the arc surges across the small gap, the weld puddle can vaporize (explode) so as to cause uneven cladding.

In the spray or globular transfer method, the wire does not short circuit to the substrate by touching the substrate surface. Instead, the spray arc transfer uses relatively high voltage, wire feed speed and amperage as compared with the short circuit transfer, resulting in a high current density through the wire. This high current density produces a high degree of heat, melting the wire into droplets. The high heat in the spray generally leads to a larger, more fluid weld puddle (“improved wetting”) than that produced by the short circuit transfer process. While the resulting improved wetting of the weld puddle leads to better flow from the high heat, the higher heat input of the spray arc transfer can cause excessive melting of the substrate.

The gun position or technique refers to the way in which the gun (and weld wire) are situated relative to the workpiece. The gun position with respect to the direction of travel is said to be progressing with either a push technique (nozzle pointed opposite the direction of motion of the advancing workpiece, i.e. toward the advancing workpiece), a pull or drag technique (nozzle pointed in the direction of motion, i.e. the torch is “dragged” away from the deposited weld), or a perpendicular technique. A perpendicular technique means that the wire is fed straight into the weld at an angle of 90 degrees relative to the surface of the substrate.

The travel angle is the angle of the torch and wire relative to the perpendicular, in other words, zero degrees from a vertical line drawn upward from the surface of the workpiece. The travel angle is defined as the angle relative to this perpendicular value of zero and in the direction of the weld. A product manual for a Gas Metal Arc Weld (GMAW) system produced by Miller Electric Manufacturing Company of Appleton, Wis. (such as that used in an embodiment of the present invention) indicates that “normal welding conditions in all positions call for a travel angle of 5 to 15 degrees [from the perpendicular] for good weld puddle control.” The manual also states that “travel angles beyond 20 to 25 degrees lead to more spatter, less penetration and general arc instability.” See Miller Electric Manufacturing Company GMAW Product Manual, page 47.

In addition to limiting the travel angle of the torch, to aid in the wire transfer process, a shielding gas is fed through the gun to provide a “blanket” over the weld to protect the weld from oxidation and contaminants. Argon is a common shielding gas, in part, because it is heavier than air and therefore provides a fairly stable coverage. Although argon is suitable for non-ferrous metal and alloys, if it is used for welding steel, the process becomes unstable and the weld profile uneven. Carbon dioxide shielding gas, while currently one of the least expensive shielding gases, is not suitable for use with stainless steel because it reduces the corrosive resistance of the weld. Generally, the flow of gas provides a cleaning action over the weld and helps to provide a more stable arc between the welder and the workpiece. The flow necessary for good welding depends primarily on the thickness of the material, the welding current, the size of the nozzle, the joint design, the specific gas coverage, and the type of gas used.

Typically, it is very difficult with the short circuit process to maintain a stable process at high deposition rates. In general, the short circuit transfer process results in a rough deposition deposit with a relatively significant crown height. For work pieces to be used with seals, the deposition surface must be machined smooth to facilitate a proper seal; however, the clad surface of the short circuit transfer deposition (because of the crown height of the clad and the roughness of the deposition) requires multiple passes of the machining process in order to achieve the requisite surface. The multiple passes significantly slow the production time. Moreover, the wasted material that is ground away from the work piece adds significantly to the production costs and the overall waste.

Thus, the traditional short circuit transfer process suffers from arc instability and uneven cladding, requiring costly downstream machining and polishing. The spray technique provides a more stable transfer, but the high heat required to generate the spray can cause excessive melting.

### BRIEF SUMMARY OF THE INVENTION

A system and method for cladding utilizes a gas metal arc welding system and a high energy beam. The gas metal arc welding system has a torch and a wire fed by a wire feeder for depositing cladding material onto a target on a substrate. The high energy beam is focused on the substrate to assist fusion and wetting of the clad material to the substrate.

### BRIEF DESCRIPTION OF THE DRAWINGS

FIG. 1 is a block diagram of the laser cladding system of the present invention.

FIG. 2 is a block diagram illustrating the angle of the torch from normal relative to a workpiece.

FIG. 3 is a front plan view of the system of the present invention.

FIG. 4 is a block diagram of the laser cladding system of the present invention from a profile view.

FIG. 5 is a top plan view of a workpiece being processed with the laser cladding system of the present invention.

FIG. 6 is a top plan view of a cylindrical workpiece being processed with the laser cladding system of the present invention with the differentially focused beam at an angle relative to normal.

FIG. 7 is a graph illustrating an example of power delivered by the differentially focused beam relative to the width of a workpiece.

FIG. 8 is a top plan view of the system of the present invention.

### DETAILED DESCRIPTION

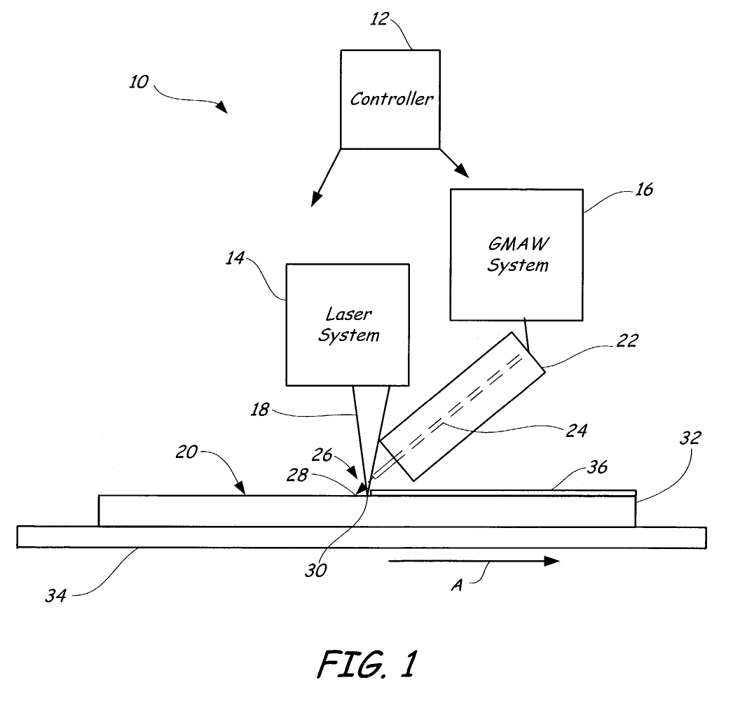

As shown in FIG. 1, the cladding system 10 includes a controller 12 for controlling a laser system 14 and a gas metal arc welder (GMAW) or a gas metal arc welder pulsed (GMAW-P) system 16. The laser system 14 focuses a beam 18 onto a surface 20 of a substrate 32. The GMAW 16 generally supplies a torch 22 with a wire 24 fed by a wire feeder (not shown). The GMAW 16 generally includes the torch 22, a power supply (not shown), a cover gas and supply line (not shown), and the wire feeder. The wire 24 extends out of the end of the torch 22 toward the beam 18 and angled toward a target location 28 on the surface 20. The target location 28 may be coincident with the focal area 30 of the laser beam 18 or the target location 28 may lead the focal area 30.

As the tip of the wire 24 melts, a spray or arc cone 26 of the molten wire material is directed toward the surface 20 of the substrate 32. The term “arc cone” generally refers to the conical shape of the spray (continuous or pulsed) of molten material generated by the torch 22. The continuous or pulsed spray of molten material does not extend in a stream or straight line, but rather in a cone-shape toward the surface 20. The arc cone 26 therefore refers to the cone shaped spray area produced by the torch 22. Generally, the GMAW 16 controls a current to the wire 24, which melts the wire 24 into the arc cone 26 aimed at a target 28 on the surface 20. The GMAW 16 also controls delivery of a shielding gas (not shown) to the torch 22 to cover the arc cone 26 to prevent contaminants from interfering with the process.

The laser beam 18 is focused differentially at a focal area 30 on the surface 20 of the substrate 32, as the substrate 32 is advanced in the direction of motion (A) by a delivery system 34, such as a conveyor. Generally, the laser beam 18 is focused at a focal area 30 between the torch 22 and the target location 28; however, sometimes the beam 18 may be focused at a focal area 30 that is coincident with the target location 28, depending on the particular application. Ordinarily, laser beams are focused to a focal point or spot on a surface. This type of focus may be viewed as a Gaussian-type energy distribution. For area cladding, the traditional focused spot or even a defocused spot centers the energy toward the beam center, therefore failing to heat the substrate evenly, which may lead to uneven flow of the cladding material and uneven bonding to the substrate.

In this instance, the beam 18 is differentially focused. The phrase “differentially focused” refers to a technique for focusing the beam 18 into a substantially linear or slit-like shape (similar to a mostly closed cat's eye). More specifically, “differentially focused” means creating a substantially linear focus for the laser beam, allowing for adjustment of the “line” length and of the energy distribution alone the so-called “line”. The term “line” is provided in quotations to illustrate that the focal area of the beam 18 is typically not reduced to a line, but rather to an elongated elliptical shape, a slit-like shape, or an elongated rectangular shape. However, the ideal focus would be a very narrow rectangle, which would appear more or less as a line.

One technique for providing the differential focus of the beam 18 uses a segmented mirror that breaks the incoming beam into small squares or rectangles and distributes the energy appropriately along the focal line. A second technique is to sweep the beam 18 back and forth across the surface with a galvanometer-driven mirror at a high rate of speed, typically 50 to 200 Hz. If the laser is varied relative to the beam position, the average energy distribution along the line can be controlled. Another technique involves two “crossed” cylindrical optics to create a line focus.

In a preferred embodiment, the laser beam 18 strikes the surface 20 of the substrate 32 at an angle that is normal to the surface 32. Off normal angles may be used to avoid reflections or for other process related issues, depending on the particular application.

As shown in FIG. 1, the tip of the wire 24 may extend partially into the differentially focused beam 18, allowing the differentially focused beam 18 to assist in the transfer. Specifically, the arc cone 26 is directed to a target location 28 in advance of the focal line 30 of the beam 18, relative to the direction of travel of the substrate 32 (as indicated by the arrow labeled with the letter A). The shadow cast by the wire 24 in the differentially focused beam 18 does not significantly effect the bonding of the clad deposit to the substrate.

In this non-contact “spray” mode with the wire 24 extending into the beam 18, the laser beam 18 assists in heating the wire 24, in addition to heating the substrate 32. In current controlled GMAW and GMAW-P systems 16, the heating of the wire 24 provided by the beam 18 reduces the power consumption, as less current from the GMAW 16 is required to melt the clad wire 24. The arc cone 26 is directed toward the target location 28 (shown in phantom), and the droplets tend to spray onto the surface 20 in a cone-shaped spray arc 26. The droplets land on the surface 20 in the vicinity of the target location. Thus, the differentially focused beam 18 heats the melt puddle of the clad material, thereby assisting in wetting out the clad and producing a smoothly finished clad deposit 36.

In one embodiment, the distance between the contact tip of the torch 22 and the target location 28 along a target line (shown in phantom) is between 0.75 to 1.00 inches. The relative distance between the focal area 30 of the beam 18 and the target location 28 for the arc cone 26 is determined by the position of the torch 22 and the laser 14. However, in some instances, it may be desirable to extend the distance between the target location 28 and the focal area 30 of the beam 18, in which case the torch 22 or the laser 14 may be moved so that the distances may be further adjusted.

The differentially focused beam 18 is directed onto the substrate at an angle that is approximately normal to the surface 20, so as to maximize absorption of laser energy by the substrate 32. The beam 18 heats the substrate 32 so as to assist in wetting of the molten clad material to the substrate. This deposition technique results in a clad deposit 36 with minimal porosity (minimal voids) and a relatively smooth profile as compared with “short circuit” clads.

Generally, the cladding system 10 of the present invention utilizes a non-contact transfer technique (meaning that the wire does not contact the surface of the substrate) for depositing the clad deposit 36 as a spray-type deposition onto the surface 20 of a substrate 32. The droplet sizes of the spray of the cladding material vary. Droplets vary in size from very small droplets relative to the diameter of the wire 24 (spray transfer) to larger droplets comparable to or larger than the diameter of the wire 24 (globular transfer). In one embodiment, the spray droplets are of approximately equal diameter. Typically, a non-contact transfer may be either a spray or a globular transfer. In the present invention, the arc cone 26 refers to either the globular or the spray deposition technique.

The substrate 32 (or workpiece) shown is one type of substrate that can be treated with the system 10; however, other shapes may be treated with the system 10 by advancing the particular workpiece under the beam 18 and torch 22 on a delivery system 34. Depending on the particular application and type of workpiece, the delivery system 34 may be a conveyor belt, a spindle with a mounting apparatus, or any other mechanism for positioning and/or rotating a workpiece in the path of the laser beam. FIG. 1, the delivery system 34 is shown as a flat surface.

Additionally, though the present invention is shown as depositing a clad deposit 36 across an entire surface of a substrate 32, the system 10 may be used to clad an area of a substrate 32. For example, the substrate 32 could be provided with a groove or pattern carved in a surface 20, and the system 10 can be adjusted to area clad the groove or pattern.

Generally, the laser 12 may be an Nd:YAG laser, a Direct Diode laser, a CO₂ laser, a fiber laser, or any other type of laser. There may be a marginal cost valuation between power consumption and workpiece production speed depending on the cladding and workpiece material properties. For fastest production without concern for power consumption or system costs, the Nd:YAG laser may a good choice. By contrast, for improved power consumption efficiency and slightly slower production speeds, the more economical CO₂ laser may be a better choice. In one embodiment, the CO₂ laser was made by Trumpf Inc. of Farmington, Conn., and the gas metal arc welder system was produced by Miller Electric Manufacturing Company of Appleton, Wis. The Miller system is a pulsed Gas Metal Arc Welding (GMAW) system, operated in spray transfer mode. However, other gas metal arc welding systems may be used.

In a preferred embodiment, the GMAW welder 26 is run in a pulsed mode, spray transfer mode of operation. Since pulsed-spray transfer uses two heat levels, the system runs at a lower average heat level than standard spray transfer, which is continuous. A system operator selects the frequency of pulse (pulses per second), the peak power (a peak pulse amplitude), the background power, and the wire feed speed on the wire feeder. Alternatively, the system operator can use a controller that automatically sets peak, background and wire feed speed for a given wire diameter and metal type.

In the pulse spray transfer, the GMAW 16 and/or a pulse controller pulses the welding output with high current peaks that are set by the operator at a selected amperage level, which will cause the wire to melt and transfer to the substrate as a spray. Generally, the pulsed GMAW system 16 operating in spray transfer mode melts the cladding material delivered as a cold wire 24 into a spray of droplets. A control unit 12 allows the user to manipulate the GMAW 16 settings (including the spray area and the coverage) to control the spray for area treatment of a substrate 32. The background current is set at a level sufficient to maintain the arc between the current peaks, but at a much lower level than the pulses. When pulsing, the peak current (or spikes) is superimposed upon the background current. The metal from the wire melts and transfers at the pulse current level and is not transferred at the background current level. When properly adjusted, small molten drops of metal are transferred during each pulse. Though the metal is transferred only during the pulse cycle, the wire feed speed is constant from a constant speed feeder.

Generally, the pulsed mode spray transfer offers several advantages over continuous spray transfer. Specifically, by operating in the pulsed mode, the GMAW 16 reduces energy consumption, reduces dilution, reduces heat, and improves process stability.

The wire 24 may be a standard, off-the-shelf solid or cored wire having a selected chemical composition. If tolerance is fairly high for mixing with the underlying substrate, the off-the-shelf wire may be more than adequate for meeting the project specifications. Alternatively, the clad wire 24 may be a custom solid or a metal cored wire of a particular chemistry. A metal cored wire has a conductive sheath wrapped around a lower-conductivity metal alloy powder core. The metal cored wire offers two advantages over off the shelf wire: 1) the chemical content of the cladding deposit must be tightly controlled, the custom solid or metal cored wire allows custom compositions so that the clad deposit will meet the product requirements, and 2) the metal cored wire requires less current to melt the wire because the current density is higher in the metallic sheath than if the entire wire were conductive.

The metal alloy powder contained within the metal cored wire or the metal of the solid wire provides the clad material for the deposit. Clad material is generally selected according to its material properties, such as corrosion resistance, wear resistance, conductivity, temperature resistance, strength, and the like. The predominant physical characteristics selected for cladding are typically wear resistance and corrosion resistance. Typical cladding materials include stainless steels, cobalt alloys, nickel alloys, aluminum alloys, and other metals with desirable material properties.

As previously discussed, traditional laser systems focus the laser beam to a focal point or spot on the surface of the workpiece. A defocused spot provides most of the energy down the center of the beam. In the case of a grooved surface, the defocused spot would focus most of the beam energy down the middle of the groove. In the present invention, the beam 18 is focused differentially using two cylindrical lenses to produce a narrow slit or “cat's eye” shape in order to more uniformly heat the substrate 32. The differentially focused beam 18 is focused to provide uniform energy distribution across the surface 20 of the area of the substrate 32 to be clad. Ultimately, the shape of the beam 18 can vary according to the surface 20 of the substrate 32 in order to control the energy distribution. In the embodiment shown, the focused beam 18 has a spot shape that is almost linear to facilitate even energy distribution. The differentially focused beam 18 thus uniformly heats the surface 20 of the substrate 32 across the entire width of the surface 20 to be clad.

Once the cladding process is completed, further processing of the cladded substrate 32 may be performed, such as machining and polishing to provide a uniformly smooth surface. However, the relative height of the cladding crown is 1.5 to 2 times smaller than the crown of a short-circuit clad deposit. Thus, significantly less downstream processing is required to produce a finished workpiece.

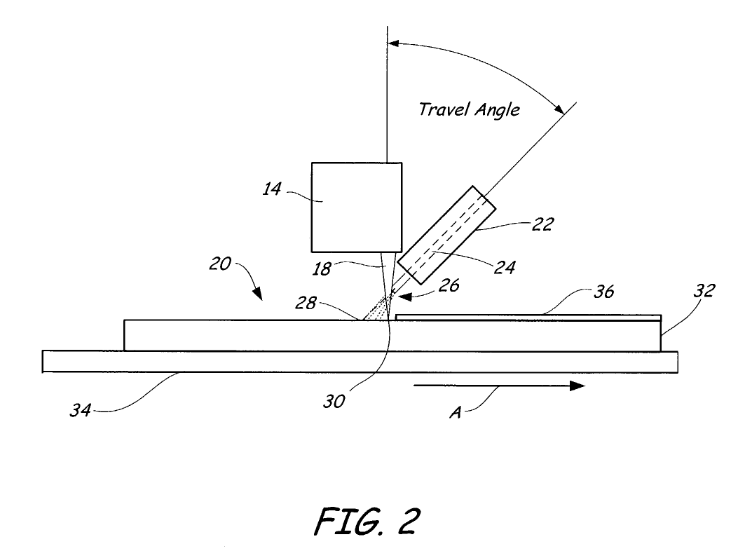

As shown in FIG. 2, the torch 22 is progressing in a push technique relative to the direction of motion of the workpiece (indicated by A). The push technique helps to provide a flatter surface of the clad deposit and a high quality deposit (with minimal porosity) at high feed rates.

The angle of the torch 22 relative to a perpendicular line extending from the surface 20 of the substrate 32 is referred to as the “travel angle”. Generally, the perpendicular line is referred to as a zero angle, such that the travel angle is the angular difference from the perpendicular. Unlike traditional welding techniques, the travel angle of the present invention is generally greater than 15 degrees. The travel angle of the torch 22 may vary according to the specific implementation. As the travel angle increases, the level of dilution of the cladding deposit 36 from the underlying substrate 32 decreases. Preferably, the travel angle is between 30 and 45 degrees. However, depending on the angle of the surface 20 to be clad, the travel angle may be adjusted to exceed 45 degrees in certain circumstances, such as where the surface 20 is at an angle relative to the horizontal plane of motion. Generally, the travel angle is greater than 15 degrees.

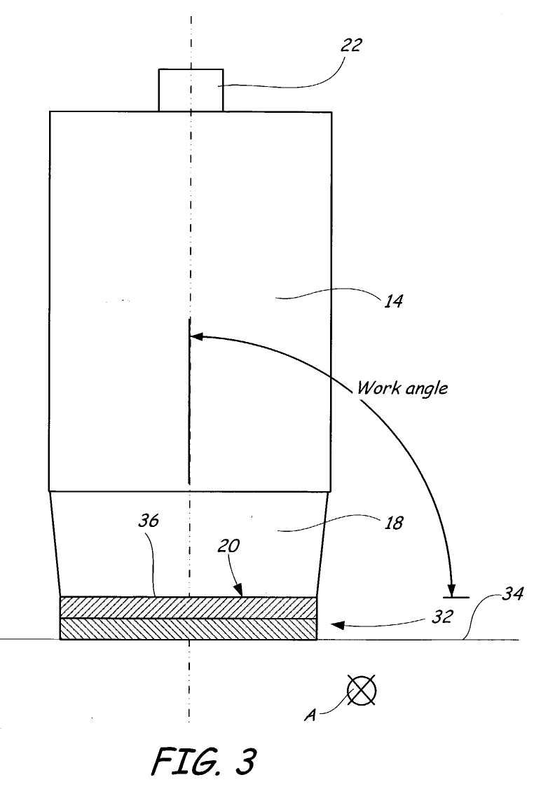

FIG. 3 illustrates a work angle of the torch 22 and the laser 14. As shown, both the torch 22 and the laser 14 are oriented at a work angle of 90 degrees relative to the surface 20 of the substrate 32 (from the position of the workpiece advancing into the page away from the viewer). Tilting of the torch 22 and/or the laser 14 may be desirable under certain circumstances, such as when the laser 14 or the torch 22 have limited access to the area to be clad. In general, the work angle is 90 degrees relative to the surface 20 of the substrate 32.

The torch 22 is preferably positioned in plane with the laser beam 18 and the direction of travel (e.g. the workpiece 32 advancing directly into the page). The phrase “in plane” is intended to indicate that the laser 14 and the torch 22 are aligned (one behind the other) in the direction of motion.

As shown, the differentially focused beam 18 converges to the width of the area to be clad as it travels from the laser 14 to the substrate 32. As previously discussed, the focal area 30 is designed to cover the entire area to be clad. The focal area 30 may be made wider or narrower as needed. While the clad area has been shown to be the entire width of a workpiece surface 20, it should be understood that the clad area may be less than the width of a workpiece surface. For example, the clad area may be a groove or a pattern traced on the surface, and the focal line 30 may be sized to cover just the groove or the traced pattern in order to area clad the surface 20.

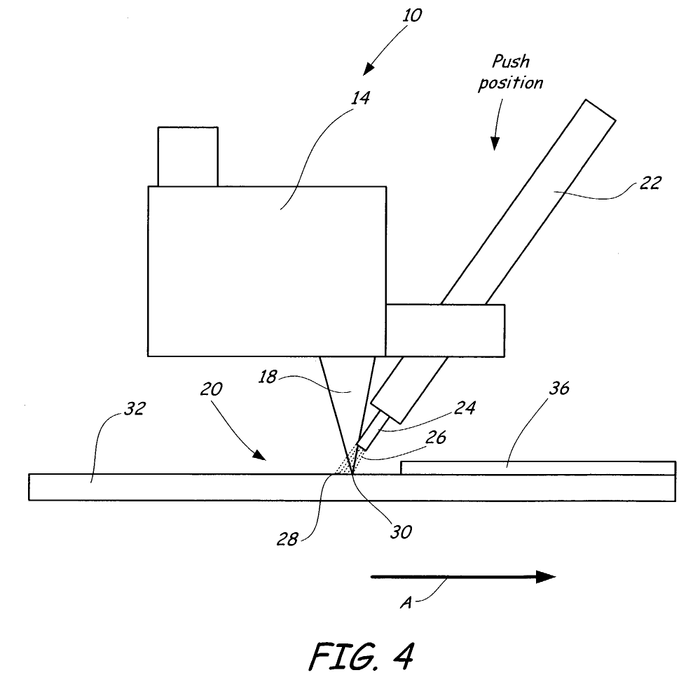

As shown in FIG. 4, the target location 28 of the arc cone 26 from the wire 24 leads the focal line 30 of the differentially focused beam 18; however, as previously discussed, the molten droplets of the clad wire 24 spray from the end of the wire 24 in an arc cone 26 that is directed toward the target location 28. Typically, the droplets of the arc cone 26 fall on the substrate 20 within the arc cone 26. For example, some of the droplets fall at the target location 28 and some fall slightly short or slightly long of the target location 28. Depending on the spacing between the focal area 30 and the target location 28, some of the droplets may fall in the focal area 30 and some ahead of the focal area 30. As shown, the focal line or area is an elongated elliptical shape or “cat's eye”. In some instances, the ideal focal area 30 may be a line or narrow rectangle.

Generally, the laser system 14 differentially focuses a beam 18 onto the surface 20 of the substrate 32. The GMAW system 22 in pulsed spray transfer mode controls a current to a wire 24 to produce an arc cone 26 aimed at a target location 28 coincident with or in advance of the focal area of the beam 18. The beam 18 is focused along a line 30 on the surface 20 of the substrate 32. Generally, the focal line 30 is oriented at an angle perpendicular to the direction of travel of the substrate 32 in the plane of the workpiece surface 20.

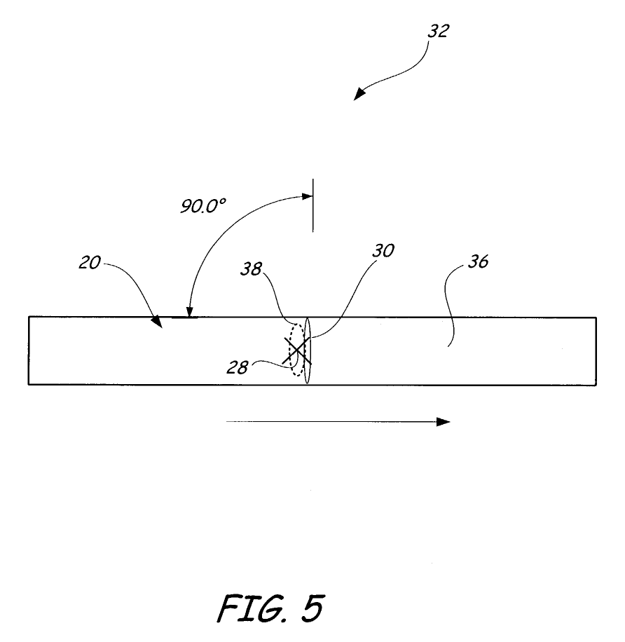

FIG. 5 shows a top plan view of the substrate 32 to show the orientation of the focal line 30 relative to the direction of motion A. As shown, in this embodiment, the target location 28 (shown as a cross-hair) and the projection 38 of the arc cone 26 on the surface 20 of the substrate 32 is shown as a semi-elliptical shape, which is intended to illustrate a deposit area of droplets at approximately the target location 28. The projection 38 of the arc cone 26 is shown in phantom to illustrate that the projection 38 may vary as the spray droplets of molten clad material land at slightly varying locations near the target location 28. Additionally, the beam 18 is oriented at an angle normal to the direction of travel (A). The normal orientation of the focal line 30 ensures uniform heating of the substrate 32 across the entire area to be clad. However, in some instances, it may be desirable to change the angle of the focal line 30.

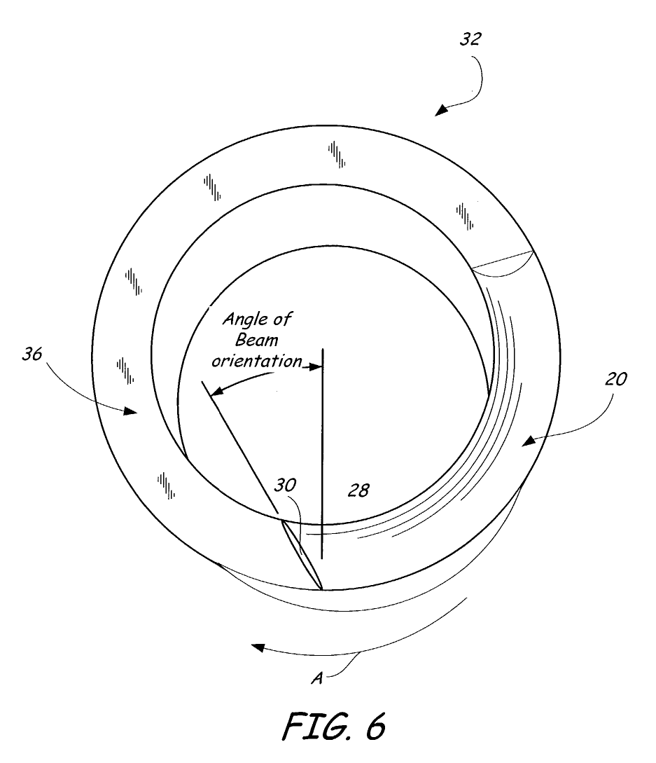

In FIG. 6, for illustration purposes, a different workpiece 32 and a different beam orientation are shown. Specifically, the workpiece 32 is cylindrical workpiece with a “concaved” or “grooved” end surface. While the previous illustrations have shown the workpiece 32 to be flat, neither the workpiece 32 nor the surface 20 need to be flat to perform the cladding process of the present invention.

With respect to the orientation of the focal line 30, it is possible to orient the focal line 30 at an angle other than normal relative to the axis of the workpiece. As shown, the focal shape of the beam 18 at the focal area 30 is elliptical and at an angle relative to the direction of travel (circle).

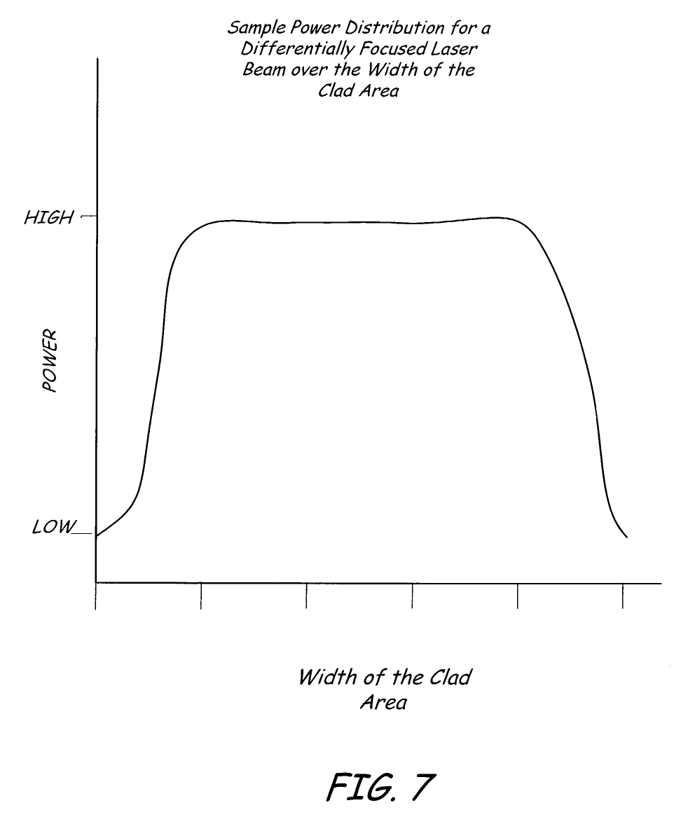

FIG. 7 illustrates the power distribution of a differentially focused beam relative to the width of a clad area. While ideally the power distribution would be uniform, some non-uniformity of the beam 18 is expected. Generally, the power is evenly distributed over the width of the clad 36. As shown, the energy distribution is at its lowest point near the edges of the area to be clad. Specifically, the graph illustrates that the power distribution of the beam 18 can be differentially focused to more uniformly heat the substrate 20, unlike a traditional de-focused laser spot.

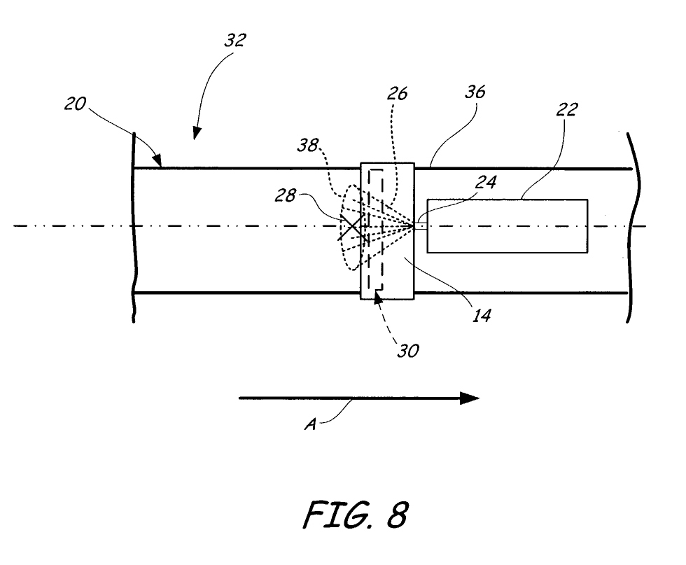

FIG. 8 is an overhead view which illustrates the focal area 30 (such as line, thin rectangle, or ellipse) at a 90° degree angle relative to the direction of motion (A). As shown, the torch 22 and the laser system 14 are positioned in-plane (in the same plane along the axis of the substrate 32) relative to the direction of motion (A). The wire target location 28 is in advance of the beam and the laser 14, such that the torch 22 directs the arc cone 26 from the wire 24 toward the target location 28. The projection 38 of the arc cone 26 is shown overlapping the target location 28. As shown, the beam 18 converges to a focal line 30 from the laser 14 to the substrate 32. The rate of convergence of the beam 18 may be varied according to the size of the area to be clad, and according to the particular application.

While the position of the torch 22 relative to the laser 14 have been consistently shown with the torch 22 trailing the laser 14 relative to the direction of motion, the torch 22 may not always trail the laser 14. In some instances, it may be desirable to reposition the torch 22 relative to the laser 14 in order to direct the arc cone 26 further in front of the focal area 30 of the beam 18.

The combination of the laser with the GMAW or GMAW-P system provides a number of advantages over traditional cladding systems. First, by spraying liquid droplets using the GMAW or GMAW-P system, the shielding gas shields the surface from contaminants, and any contaminants contained in the droplets are allowed to burn off prior to reaching the substrate. Second, the spray droplets are deposited in liquid form (as opposed to pre-placed or propulsed powder deposition), allowing the droplets to flow evenly on the surface, and providing a clad deposit with minimal porosity (minimal voids). The GMAW-P system provides the additional advantage of operating in a pulsed mode, allowing for lower average power consumption.

In addition to the laser beam 18 being used to heat the surface 20 of the substrate 32, the laser beam 18 is used sometimes to heat the wire 24 or the spray droplets 26. By concurrently or simultaneously heating the wire 24 and the substrate 32, the laser beam 18 can improve wetting and reduce the average power required by the GMAW system 16. Conversely, by concurrently or simultaneously heating the spray droplets 26 and the substrate 32, the liquid flow of the droplets or the liquid clad deposit is improved, and complete fusion between the substrate 32 and the clad deposit 36 is achieved.

By heating the substrate 32 with a beam 18 from a laser 14 and by spraying the molten clad material in an arc cone 26 from the wire 24 of a GMAW system 16 toward a target location 28, the liquid flow of the droplets is improved and complete fusion between the substrate 32 and the clad deposit 36 is achieved over the width of the clad area. Heating the substrate 32 coupled with spray depositing the clad deposit assists the melt puddle flow, allowing the sprayed droplets to cool more slowly for better droplet flow. The heated substrate 32 allows the melt puddle of clad material to flow more evenly to fill minute unevenness in the surface 20 of the substrate 32, thereby ensuring a better interface between the substrate 32 and the clad deposit 36.

Heating of the substrate 32 with the laser beam 18 ensures that the interface between the clad deposit 36 and the substrate 32 is a fusion bond. Specifically, the bond is metallurgical in the sense that the heated substrate surface 20 and the clad deposit 36 bond at a molecular level, rather than just mechanically, as would be the case with a plasma spray depositing the clad deposit without substrate heating.

Tests performed using lasers to clad carbon steel with stainless steel powder (using the prior art technique of pre-placement of the powder) showed that an Nd:YAG laser was capable of completing the cladding operation at a linear feed rate of 15 inches per minute. Attempts to use the CO₂ laser to clad the carbon steel workpiece using the prior art pre-placement method were unsuccessful.

With the GMAW system in conjunction with the CO₂ laser, specifically using a Gas Metal Arc Welding system produced by Miller® and a CO₂ laser system produced by Trumpf, the present invention successfully clad a 420 grade stainless steal wire of 0.062 inch diameter onto a carbon steel workpiece at a linear feed rate of greater than 40 inches per minute.

In this embodiment, the GMAW system was operated using an Argon/CO₂ cover gas mixture of 95/5 ratio at a flow-rate of 50 cubic feet per hour. Other mixtures have also been tested. With stainless steels cladding onto steel substrates, other mixtures of Argon/CO₂, as well as mixtures of Argon/O₂ and Argon/CO₂/NL were found to be effective. Generally, the specific aplication dictates which cover gas is most suitable.

Generally, the best incidence angle for absorption of the laser beam 18 is at an angle normal to the surface of the workpiece. The travel angle and position of the torch 22 may be varied according to the specific application. In particular, the torch angle and position may be adjusted using the control unit 12, or by manually adjusting the welder. The torch angle may be adjusted to control the placement of the clad deposit relative to the laser beam 18 in relation to the motion of the substrate 32.

In the present invention, the controller is an AccuNav™ controller, produced by Preco Laser Systems of Somerset, Wis. The AccuNaV™ controller allows for computer control of large, complex operations by storing set-up and process details in the database for reliable and reproducible results. Other control units may also be capable of such control functions.

As described above, by combining laser and gas metal arc welding systems, a selected material can be deposited on the surface of a substrate in a productive, efficient, low-heat input process. By utilizing gas metal arc systems, area improvements and repairs can be made faster and with complete fusion, minimizing contamination and porosity (void) problems.

Finally, as previously mentioned, when dilution between the cladding deposit 36 and the underlying substrate 32 must be tightly controlled, a special composition wire 24 (solid or cored) may be utilized to adjust the chemistry of the clad deposit so as to account for some mixing. Additionally, the travel angle of the torch 22 may be adjusted to improve process results.

Generally, the present invention assumes that there will be some dilution. The reduction in downstream processes required to finish the substrate 32 justifies the dilution relative to the higher crown of the short-circuit arc welding process. Moreover, the speed and quality of finish (including minimal porosity) produced by the system of the present invention justifies the dilution as well.

Although the present invention has been described with reference to preferred embodiments, workers skilled in the art will recognize that changes may be made in form and detail without departing from the spirit and scope of the invention.

1. A method for area cladding a substrate comprising:
heating a surface of the substrate with a high energy beam; and
cladding a deposit material onto the surface of the substrate via a non-contact transfer process.

2. The method of claim 1 wherein the step of cladding further comprises:
melting a wire with a gas metal arc welder to produce a spray; and
directing the spray to a target location on the surface of the substrate in front of the high energy beam relative to a direction of motion.

3. The method of claim 1 wherein the step of cladding further comprises:
melting a wire with a gas metal arc welder to produce a spray; and
directing the spray to a target location on the surface of the substrate coincident with a focal area of the high energy beam relative to a direction of motion.

4. The method of claim 1 wherein the step of heating further comprises:
differentially focusing the high energy beam into a substantially linear shape; and
directing the high energy beam onto the surface of the substrate.

5. The method of claim 4 wherein the substantially linear shape of the differentially focused high energy beam is oriented at an angle that is substantially normal to a direction of motion of the substrate.

6. The method of claim 4 wherein the beam heats the surface of the substrate substantially uniformly across a width of a clad area.

7. The method of claim 1 further comprising:
selecting the deposit material according to at least one physical characteristic.

8. The method of claim 7 wherein the at least one physical characteristic is corrosion resistance.

9. The method of claim 7 wherein the at least one physical characteristic is strength.

10. The method of claim 7 wherein the at least one physical characteristic is wear resistance.

11. The method of claim 1 wherein the high energy beam is a laser.

12. The method of claim 1 wherein the non-contact transfer is a spray transfer.

13. The method of claim 1 wherein the non-contact transfer is a globular transfer.

14. The method of claim 1 wherein the step of cladding further comprises:
selecting a clad wire according to a desired chemical content of the deposit material;
melting the clad wire into a spray; and
directing the spray onto the surface of the substrate.

15. The method of claim 1 wherein the step of cladding comprises:
configuring a gas metal arc welding system for pulsed mode spray transfer;
adjusting the gas metal arc welding system to control an arc; and
melting the deposit material with the gas metal arc welding system into a spray of molten droplets directed toward the surface of the substrate.

16. The method of claim 1 wherein the deposit material is either a solid wire or a metal cored wire.

17. A method for area cladding a substrate comprising:
heating a surface of the substrate with a differentially focused beam; and
depositing molten droplets of deposit material onto the surface of the substrate.

18. The method of claim 17 wherein the step of cladding further comprises:
melting a wire with a gas metal arc welder to produce a spray; and
directing the spray to a target location on the surface of the substrate in front of the high energy beam relative to a direction of motion.

19. The method of claim 17 wherein the step of cladding further comprises:
melting a wire with a gas metal arc welder to produce a spray; and
directing the spray to a target location on the surface of the substrate coincident with a focal area of the high energy beam relative to a direction of motion.

20. The method of claim 17 wherein the step of heating further comprises:
differentially focusing the high energy beam into a substantially linear shape; and
directing the differentially focused high energy beam onto the surface of the substrate.

21. The method of claim 20 wherein the substantially linear shape of the differentially focused high energy beam is oriented at an angle that is substantially normal to a direction of motion of the substrate.

22. The method of claim 17 wherein the differentially focused beam heats the surface of the substrate substantially uniformly across a width of a clad area.

23. The method of claim 17 further comprising:
selecting the deposit material according to at least one physical characteristic.

24. The method of claim 23 wherein the at least one physical characteristic is corrosion resistance.

25. The method of claim 23 wherein the at least one physical characteristic is strength.

26. The method of claim 23 wherein the at least one physical characteristic is wear resistance.

27. The method of claim 17 wherein the high energy beam is a laser.

28. The method of claim 17 the step of depositing comprises:
transferring the deposit material via a non-contact transfer technique.

29. The method of claim 28 wherein the non-contact transfer is a globular transfer.

30. The method of claim 17 wherein the step of depositing further comprises:
selecting a clad wire according to a desired chemical content of the deposit material;
melting the clad wire into a spray; and
directing the spray onto the surface of the substrate.

31. The method of claim 17 wherein the step of cladding comprises:
configuring a gas metal arc welding system for pulsed mode spray transfer;
adjusting the gas metal arc welding system to control an arc; and
melting the deposit material with the gas metal arc welding system into a spray of molten droplets directed toward the surface of the substrate.

32. A system for cladding a deposit of a selected material onto a surface of a substrate, the system comprising:
a laser system for delivering a laser beam onto the surface of the substrate at an angle that is normal to the surface of the substrate;
a gas metal arc welding system having a torch and a wire feeder for feeding a wire to the torch, the torch being positioned in plane with the laser beam relative to the direction of motion of the substrate and at a travel angle greater than about 15 degrees relative to a line perpendicular to the surface of the substrate, the gas metal arc welding system for controlling delivery of a current to the wire to melt the wire into a spray of droplets, the torch for directing the wire and spray of droplets toward a target location on the substrate;
a substrate delivery system for delivering substrates into a process zone of the laser system and the gas metal arc welding system; and
a controller for synchronizing and controlling the laser system and the gas metal arc welding system relative to the substrate delivery system.

33. The system of claim 32 wherein the substrate delivery system is a conveyor belt.

34. The system of claim 32 wherein the target location is in front of the laser beam relative to the direction of motion of the substrate.

35. The system of claim 32 wherein the laser beam is differentially focused into a narrow elliptical shape.

36. The system of claim 32 wherein the laser beam is differentially focused into a substantially linear shape.

37. The system of claim 35 wherein the narrow elliptical shape is oriented at an angle other than normal relative to the direction of motion of the substrate.

38. The system of claim 32 wherein the travel angle is between 30 and 45 degrees.

39. The system of claim 32 wherein the wire is a solid or a metal cored wire.

40. The system of claim 32 wherein the gas metal arc welding system is a pulsed gas metal arc welding system.

41. A method of area cladding a surface of a substrate comprising:
heating a substrate with a laser beam; and
cladding a deposit material via a non-contact transfer process onto the substrate with a gas metal arc welding system.

42. The method of claim 41 wherein a torch of the gas metal arc welding system is progressing with a push technique.

43. The method of claim 41 wherein the step of cladding further comprises:
melting a wire with the gas metal arc welder to produce a spray; and
directing the spray to a target location on the surface of the substrate in front of the high energy beam relative to a direction of motion.

44. The method of claim 41 wherein the step of cladding further comprises:
melting a wire with a gas metal arc welder to produce a spray; and
directing the spray to a target location on the surface of the substrate coincident with a focal area of the high energy beam relative to a direction of motion.

45. The method of claim 41 wherein the step of heating further comprises:
differentially focusing the laser beam into a substantially linear shape; and
directing the laser beam onto the surface of the substrate.

46. The method of claim 45 wherein the substantially linear shape of the differentially focused laser beam is oriented at an angle that is substantially normal to a direction of motion of the substrate.

47. The method of claim 45 wherein the laser beam heats the surface of the substrate substantially uniformly across a width of a clad area.

48. The method of claim 41 further comprising:
selecting the deposit material according to at least one physical characteristic.

49. The method of claim 48 wherein the at least one physical characteristic is corrosion resistance.

50. The method of claim 48 wherein the at least one physical characteristic is strength.

51. The method of claim 48 wherein the at least one physical characteristic is wear resistance.

52. The method of claim 41 wherein a clad wire extends from a torch of the gas metal arc welding system into the laser beam.

53. The method of claim 41 wherein the step of cladding further comprises:
selecting a clad wire according to a desired chemical content of the deposit material;
melting the clad wire into a spray; and
directing the spray onto the surface of the substrate.

54. The method of claim 41 wherein the step of cladding comprises:
configuring a gas metal arc welding system for pulsed mode spray transfer;
adjusting the gas metal arc welding system to control an arc; and
melting the deposit material with the gas metal arc welding system into a spray of molten droplets directed toward the surface of the substrate.

55. The method of claim 41 wherein the step of spraying comprises:
operating the gas metal arc welder in pulsed spray transfer mode;
delivering a wire to the gas metal arc welder so that a tip of the wire melts into droplets with each current pulse; and
directing the droplets onto the surface of the substrate.

56. The method of claim 55 wherein the step of directing further comprises:
directing the droplets toward a target location on the surface of the substrate ahead of the laser beam relative to the direction of motion of the substrate.

57. A method of area cladding a substrate comprising:
heating a substrate with a high energy beam; and
depositing a clad deposit on the substrate with a gas metal arc welder in a pulsed transfer mode.

58. The method of claim 57 wherein the step of depositing further comprises:
melting a wire with a gas metal arc welder to produce a spray; and
directing the spray to a target location on the surface of the substrate in front of the high energy beam relative to a direction of motion.

59. The method of claim 57 wherein the step of cladding further comprises:
melting a wire with a gas metal arc welder to produce a spray; and
directing the spray to a target location on the surface of the substrate coincident with a focal area of the high energy beam relative to a direction of motion.

60. The method of claim 57 wherein the step of heating further comprises:
differentially focusing the high energy beam into a substantially linear shape; and
directing the high energy beam onto the surface of the substrate.

61. The method of claim 60 wherein the substantially linear shape of the differentially focused high energy beam is oriented at an angle that is substantially normal to a direction of motion of the substrate.

62. The method of claim 60 wherein the beam heats the surface of the substrate substantially uniformly across a width of a clad area.

63. The method of claim 57 further comprising:
selecting the deposit material according to at least one physical characteristic.

64. The method of claim 63 wherein the at least one physical characteristic is corrosion resistance.

65. The method of claim 63 wherein the at least one physical characteristic is strength.

66. The method of claim 63 wherein the at least one physical characteristic is wear resistance.

67. The method of claim 57 wherein the high energy beam is a laser.

68. The method of claim 57 wherein the gas metal arc welder has a torch and a clad wire fed through the torch, the step of depositing comprising:
transferring the deposit material onto the substrate without contacting the clad wire to the substrate.

69. The method of claim 68 wherein the step of transferring is a spray deposition.

70. The method of claim 68 wherein the step of transferring is a globular deposition.

71. The method of claim 57 wherein the step of cladding further comprises:
selecting a clad wire according to a desired chemical content of the deposit material;
melting the clad wire into a spray; and
directing the spray toward a target location on the surface of the substrate.

72. The method of claim 57 wherein the step of cladding comprises:
adjusting the gas metal arc welding system to control an arc; and
melting the deposit material with the gas metal arc welding system into a spray of molten droplets directed toward the surface of the substrate.

73. The method of claim 57 wherein the deposit material is either a solid wire or a metal cored wire.

74. A method of area cladding a substrate comprising:
heating a substrate with a high energy beam;
positioning a gas metal arc welding system with a torch and a clad wire extending from the torch such that an end of the clad wire extends into the high energy beam; and
depositing molten droplets of the clad wire onto a surface of the substrate.

75. The method of claim 74 wherein the step of depositing further comprises:
melting the clad wire into molten droplets to produce a spray; and
directing the spray toward a target location on the surface of the substrate in front of the high energy beam relative to a direction of motion.

76. The method of claim 74 wherein the step of cladding further comprises:
melting a wire with a gas metal arc welder to produce a spray; and
directing the spray to a target location on the surface of the substrate coincident with a focal area of the high energy beam relative to a direction of motion.

77. The method of claim 74 wherein the step of heating further comprises:
differentially focusing the high energy beam into a substantially linear shape; and
directing the high energy beam onto the surface of the substrate.

78. The method of claim 77 wherein the substantially linear shape of the differentially focused high energy beam is oriented at an angle that is substantially normal to a direction of motion of the substrate.

79. The method of claim 77 wherein the beam heats the surface of the substrate substantially uniformly across a width of a clad area.

80. The method of claim 74 further comprising:
selecting the deposit material according to at least one physical characteristic.

81. The method of claim 80 wherein the at least one physical characteristic is corrosion resistance.

82. The method of claim 80 wherein the at least one physical characteristic is strength.

83. The method of claim 80 wherein the at least one physical characteristic is wear resistance.

84. The method of claim 74 wherein the high energy beam is a laser.

85. The method of claim 74 the step of depositing comprises:
transferring the molten droplets onto the substrate without allowing the clad wire to contact the substrate.

86. The method of claim 74 wherein before positioning, the method further comprises:
selecting a clad wire according to a desired chemical content of the deposit material.

87. The method of claim 74 wherein before depositing, the method further comprises:
configuring the gas metal arc welding system for pulsed mode spray transfer; and
adjusting the gas metal arc welding system to control an arc.

88. The method of claim 74 wherein the clad wire is a solid wire or a metal cored wire.
